(19) United States
(12) Patent Application Publication
(10) Pub. No.: US 2020/0331528 A1
(43) Pub. Date: Oct. 22, 2020

(54) STEERING CONTROL DEVICE, STEERING CONTROL METHOD AND RECORDING MEDIUM

(71) Applicant: ISUZU MOTORS LIMITED, Tokyo (JP)

(72) Inventors: Ryota OKEYA, Fujisawa-shi, Kanagawa (JP); Takahiro SATO, Fujisawa-shi, Kanagawa (JP); Yuta FUJIMAKI, Fujisawa-shi, Kanagawa (JP)

(21) Appl. No.: 16/760,292

(22) PCT Filed: Nov. 5, 2018
(86) PCT No.: PCT/JP2018/040959

§ 371 Date: Apr. 29, 2020

(30) Foreign Application Priority Data
Nov. 6, 2017 (JP) 2017-213553

(51) Int. Cl. B62D 15/02; G01S 13/931; G01S 13/08; G01S 13/58; G01S 13/86

(52) U.S. Cl. CPC B62D 15/025; G01S 13/931; G01S 2013/9318; G01S 13/58; G01S 13/867; G01S 13/08

(57) ABSTRACT

A vehicle control device 10 is provided with: a preceding vehicle detecting unit 123 which detects an amount of change in a lateral direction, with respect to a lane in which a vehicle is traveling, of a preceding vehicle traveling in front of the vehicle; and a steering control unit 124 which, if the detected amount of change is less than a prescribed amount, performs tracking control to control the steering of the vehicle in such a way that the vehicle tracks to the lateral position, within the lane, of the preceding vehicle, and stops the tracking control if the detected amount of change is equal to or greater than the prescribed amount.

### TECHNICAL FIELD

The present disclosure relates to a steering control device and a steering control method.

### BACKGROUND ART

There has been known a steering control device configured to perform a steering control such that a vehicle is to travel in a traffic lane during traveling. For example, PTL 1 discloses recognizing a traffic lane from a captured image ahead of a vehicle captured by an imaging device, and performing the steering control so that the vehicle is to travel along a center of the traffic lane.

### CITATION LIST

### Patent Literature

PTL 1: JP-A-2002-337714

### SUMMARY OF INVENTION

### Technical Problem

In the meantime, when a preceding vehicle traveling ahead of the vehicle is a large-sized vehicle such as a truck or the vehicle comes too close to the preceding vehicle, the traffic lane is not included in the captured image captured by the imaging device. In this case, the steering control device may perform the steering control so that the vehicle is to travel while following up a position of the preceding vehicle in the traffic lane.

However, in a case where the preceding vehicle is shakily traveling, if the vehicle travels along the position of the preceding vehicle, the straight advancing of the vehicle is deteriorated, so that the vehicle becomes unstable.

The present disclosure has been made in view of the above situations, and an object thereof is to provide a steering control device and a steering control method capable of causing a vehicle to stably travel.

### Solution to Problem

A steering control device according to a first aspect of the present disclosure is a steering control device comprising: a change amount detecting unit configured to detect an amount of change of a preceding vehicle traveling ahead of a vehicle in a lateral direction with respect to a traffic lane in which the vehicle travels; and a steering control unit configured to: in a case the detected amount of change is less than a predetermined amount, perform a follow-up control of controlling steering of the vehicle such that the vehicle is to follow up a lateral position of the preceding vehicle in the traffic lane; and in a case the detected amount of change is equal to or greater than the predetermined amount, stop the follow-up control.

The steering control device may further comprise a lateral position detecting unit configured to: obtain a captured image obtained by capturing a situation ahead of the vehicle in an advancing direction; and in a case an image expressing demarcation lines of the traffic lane is included in the captured image, detect a lateral position of the vehicle in the traffic lane, based on the image expressing the demarcation lines, wherein in a case the follow-up control is stopped, when the lateral position of the vehicle is detected by the lateral position detecting unit, the steering control unit controls steering of the vehicle based on the lateral position.

In the case the follow-up control is stopped, when the lateral position of the vehicle is not detected by the lateral position detecting unit, the steering control unit may stop the steering control of the vehicle.

A steering control method according to a second aspect of the present disclosure is a steering control method comprising: a step of detecting an amount of change of a preceding vehicle traveling ahead of a vehicle in a lateral direction with respect to a traffic lane in which the vehicle travels; and a step comprising: in a case the detected amount of change is less than a predetermined amount, performing a follow-up control of controlling steering of the vehicle such that the vehicle is to follow up a lateral position of the preceding vehicle in the traffic lane; and in a case the detected amount of change is equal to or greater than the predetermined amount, stopping the follow-up control.

A computer-readable storage medium according to a third aspect of the present disclosure is a computer-readable storage medium storing a computer program readable by a computer of a vehicle, the computer program, when executed by the computer, causes the vehicle to perform: a step of detecting an amount of change of a preceding vehicle traveling ahead of a vehicle in a lateral direction with respect to a traffic lane in which the vehicle travels; and a step comprising: in a case the detected amount of change is less than a predetermined amount, performing a follow-up control of controlling steering of the vehicle such that the vehicle is to follow up a lateral position of the preceding vehicle in the traffic lane, and in a case the detected amount of change is equal to or greater than the predetermined amount, stopping the follow-up control.

### Advantageous Effects of Invention

According to the present disclosure, it is possible to cause the vehicle to stably travel.

### BRIEF DESCRIPTION OF DRAWINGS

FIG. 1A1 illustrates an outline of a vehicle control device in accordance with the present embodiment.

FIG. 1A2 is a flowchart depicting an outline of a steering control that is executed in the vehicle control device in accordance with the present embodiment.

FIG. 1B1 illustrates an outline of the vehicle control device when a preceding vehicle is traveling ahead of a vehicle.

FIG. 1B2 is a flowchart showing an outline of the steering control that is executed in the vehicle control device when the preceding vehicle is traveling ahead of the vehicle.

FIG. 2 depicts a configuration example of the vehicle control device in accordance with the present embodiment.

FIG. 3 is a flowchart showing a flow of processing of the steering control that is executed in the vehicle control device in accordance with the present embodiment.

### DESCRIPTION OF EMBODIMENTS

[Outline of Vehicle Control Device 10]

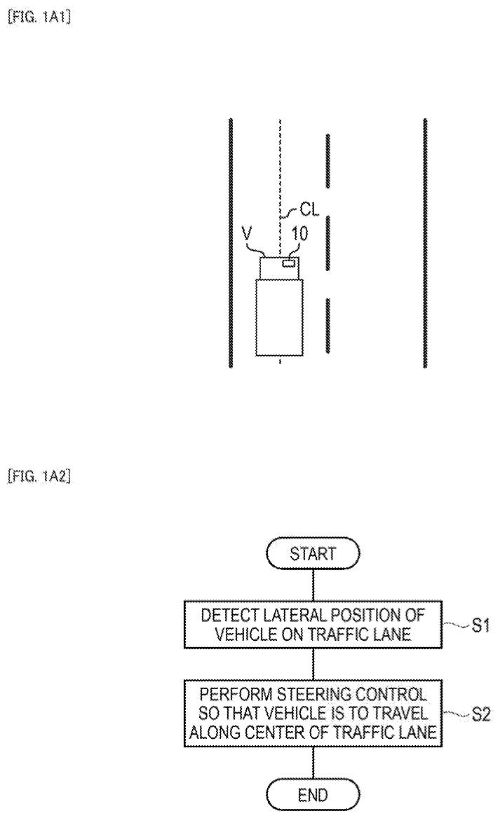

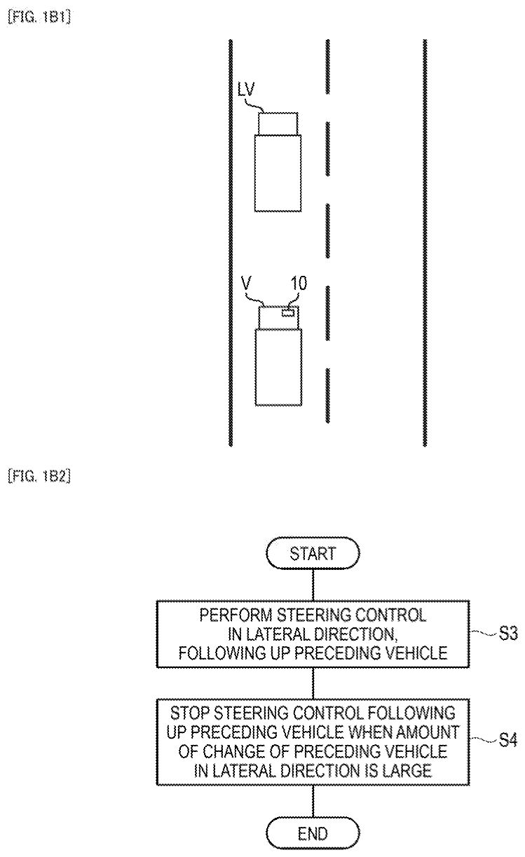

FIGS. 1A1 to 1B2 illustrate an outline of a vehicle control device 10 in accordance with the present embodiment. The vehicle control device 10 is a device for controlling traveling of a large-sized vehicle V such as a bus, a truck and the like, for example. As shown in FIG. 1A1, in a case where there is no preceding vehicle LV that is traveling ahead of the vehicle V in a traffic lane in which the vehicle V travels, the vehicle control device 10 detects a position of the vehicle V in a lateral direction in the traffic lane (S1 in FIG. 1A2). The vehicle control device 10 performs a steering control so that the vehicle V is to travel along a central line CL indicative of a center of the traffic lane, based on the detected position in the lateral direction (S2 in FIG. 1A2).

As shown in FIG. 1B1, when a preceding vehicle LV is traveling ahead of the vehicle V in the traffic lane in which the vehicle V travels, the vehicle control device 10 performs a steering control in the lateral direction of the traffic lane, following up the preceding vehicle LV (S3 in FIG. 1B2). However, there is a case where the preceding vehicle LV is shakily traveling or changes traffic lanes. For this reason, when an amount of change of the preceding vehicle LV in the lateral direction is large, the vehicle control device 10 stops the steering control following up the preceding vehicle LV (S4 in 1B2). Thereby, the vehicle control device 10 can keep straight advancing of the vehicle V and cause the vehicle V to stably travel.

Subsequently, a configuration of the vehicle control device 10 is described.

[Configuration of Vehicle Control Device 10]

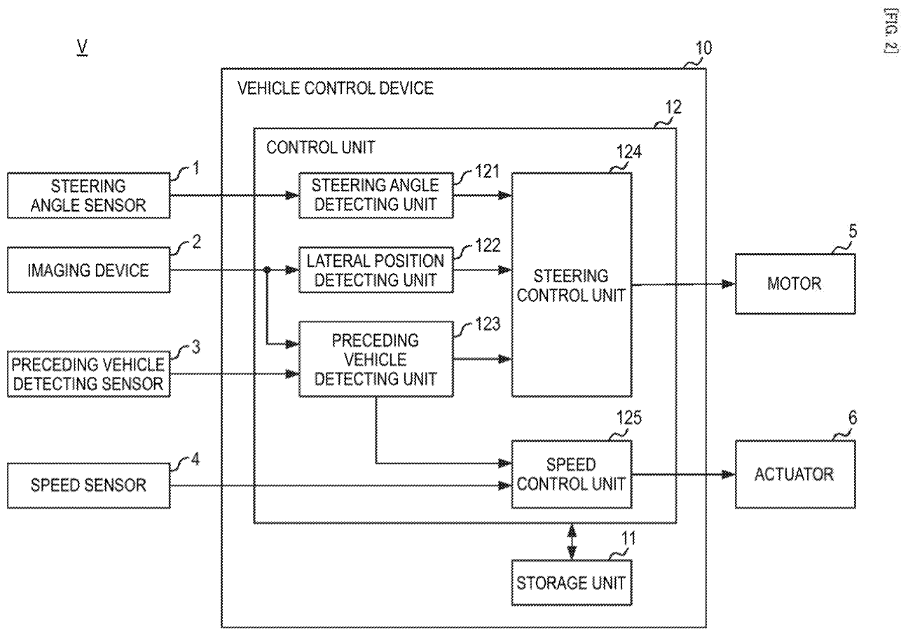

FIG. 2 depicts a configuration example of the vehicle control device 10 in accordance with the present embodiment.

As shown in FIG. 2, the vehicle control device 10 is electrically connected to a steering angle sensor 1, an imaging device 2, a preceding vehicle detecting sensor 3, a speed sensor 4, a motor 5, and an actuator 6, which are provided to the vehicle V.

The steering angle sensor 1 is provided to a steering shaft (not shown) of the vehicle V, for example, and is configured to detect a steering angle of a steering wheel (not shown) connected to the steering shaft. The steering angle sensor 1 is configured to output steering angle information indicative of an absolute value of the detected steering angle and a steering direction to the vehicle control device 10.

The imaging device 2 is configured to capture a situation in front of the vehicle V in a traveling direction, including a traffic lane in which the vehicle V is traveling, at predetermined time intervals (for example, 10 milliseconds). The imaging device 2 is configured to output the captured image to the vehicle control device 10. Here, there is a case where, when the preceding vehicle LV is traveling ahead of the vehicle V, the traffic lane is not included in the captured image captured by the imaging device 2.

The preceding vehicle detecting sensor 3 is configured to detect the preceding vehicle LV that is traveling in a predetermined range ahead of the vehicle V. The preceding vehicle detecting sensor 3 includes, for example, a millimeter wave radar provided at the front of the vehicle V. The preceding vehicle detecting sensor 3 is configured to detect the preceding vehicle LV by causing the millimeter wave radar to irradiate a millimeter wave, and receiving a millimeter wave (reflected wave) reflected on the preceding vehicle LV that is traveling in the predetermined range ahead of the vehicle V in the traffic lane in which the vehicle V is traveling.

Also, the preceding vehicle detecting sensor 3 is configured to measure a relative speed between the vehicle V and the preceding vehicle LV, based on a frequency of the millimeter wave irradiated by the millimeter wave radar and a frequency of the received reflected wave. Also, the preceding vehicle detecting sensor 3 is configured to measure a relative distance between the vehicle V and the preceding vehicle LV, based on a time after the millimeter wave is irradiated until the reflected wave is received. Also, the preceding vehicle detecting sensor 3 is configured to measure a relative position of the preceding vehicle LV to the vehicle V.

The preceding vehicle detecting sensor 3 is configured to output, to the vehicle control device 10, preceding vehicle information indicative of the measured relative speed, relative distance and relative position between the vehicle V and the preceding vehicle LV. Also, when the preceding vehicle LV is not detected, the preceding vehicle detecting sensor 3 outputs, to the vehicle control device 10, non-detection information indicating that the preceding vehicle LV is not detected.

In the present embodiment, the preceding vehicle detecting sensor 3 is configured to detect the preceding vehicle LV by using the millimeter wave radar. However, the present disclosure is not limited thereto. For example, the preceding vehicle detecting sensor 3 may be configured to detect the preceding vehicle LV, based on an image captured by an imaging device configured to capture a situation around the vehicle V. Also, the preceding vehicle detecting sensor 3 may be configured to detect the preceding vehicle LV by inter-vehicle communication or road-to-vehicle communication.

The speed sensor 4 is configured to detect a speed of the vehicle V. The speed sensor 4 is configured to output speed information indicative of the speed of the vehicle V to the vehicle control device 10.

The motor 5 is provided to the steering shaft (not shown) of the vehicle V. The motor 5 is rotatively driven by power that is fed from the vehicle control device 10, thereby applying torque to the steering shaft to perform a steering operation. The motor 5 functions as a steering assisting unit configured to perform steering assistance for the vehicle V to travel along a travel traffic lane.

The actuator 6 includes a drive actuator and a braking actuator. The drive actuator is configured to control a degree of throttle opening of an engine (not shown), thereby changing the speed of the vehicle V, in accordance with a control of the vehicle control device 10. The braking actuator is configured to operate a brake (not shown), thereby braking the vehicle V, in accordance with a control of the vehicle control device 10.

The vehicle control device 10 includes a storage unit 11 and a control unit 12.

The storage unit 11 is, for example, a ROM (Read Only Memory), a RAM (Random Access Memory) or a hard disk drive. The storage unit 11 stores a variety of programs for causing the control unit 12 to function. The storage unit 11 stores a vehicle control program for causing the control unit 12 to function as a steering angle detecting unit 121, a lateral position detecting unit 122, a preceding vehicle detecting unit 123, a steering control unit 124, and a speed control unit 125.

The control unit 12 is, for example, a CPU (Central Processing Unit). The control unit 12 is configured to function as the steering angle detecting unit 121, the lateral position detecting unit 122, the preceding vehicle detecting unit 123, the steering control unit 124, and the speed control unit 125 by executing the vehicle control program stored in the storage unit 11.

The steering angle detecting unit 121 is configured to detect a steering angle of the vehicle V, based on the steering angle information output from the steering angle sensor 1.

The lateral position detecting unit 122 is configured to obtain a captured image ahead of the vehicle V in an advancing direction, which is captured by the imaging device 2. The lateral position detecting unit 122 is configured to analyze the captured image and, when an image representing demarcation lines for demarcating a traffic lane is included in the captured image, the lateral position detecting unit 122 calculates a traffic lane width, based on positions of the demarcation lines. The lateral position detecting unit 122 is configured to detect a lateral position of the vehicle V in the traffic lane, based on a position of the image representing the demarcation lines in the captured image.

The preceding vehicle detecting unit 123 is configured to obtain a captured image ahead of the vehicle V in the advancing direction, which is captured by the imaging device 2. The preceding vehicle detecting unit 123 functions as a change amount detecting unit, and is configured to detect an amount of change of the preceding vehicle LV in a lateral direction with respect to the traffic lane, which is traveling ahead of the vehicle V in the traffic lane in which the vehicle V travels.

Specifically, first, when the preceding vehicle LV is not included in the captured image, the preceding vehicle detecting unit 123 detects the demarcation lines of the traffic lane in which the vehicle V travels, and calculates a traffic lane width, based on positions of the demarcation lines. Herein, the preceding vehicle detecting unit 123 is configured to detect two demarcation lines for demarcating the traffic lane, and calculates a traffic lane width, based on a distance between the two demarcation lines.

When the preceding vehicle LV is included in the captured image, the preceding vehicle detecting unit 123 detects at least one of the two demarcation lines and specifics a center position of the preceding vehicle LV in the lateral direction. Then, the preceding vehicle detecting unit 123 is configured to calculate a lateral position of the preceding vehicle LV on the basis of a center of the traffic lane, based on the detected demarcation line, the specified center position, and the traffic lane width calculated in advance. The preceding vehicle detecting unit 123 is configured to calculate the lateral position of the preceding vehicle to LV on the basis of the center of the traffic lane, at predetermined time intervals. Then, the preceding vehicle detecting unit 123 is configured to calculate an amount of instantaneous change in lateral position, based on the lateral positions calculated at each time, and to sum the amounts of instantaneous change, thereby calculating an amount of lateral change of the preceding vehicle LV per unit time.

Also, the preceding vehicle detecting unit 123 is configured to obtain the preceding vehicle information from the preceding vehicle detecting sensor 3, thereby detecting the relative speed, relative distance and relative position between the preceding vehicle LV and the vehicle V.

The steering control unit 124 is configured to control the motor 5, based on the steering angle detected by the steering angle detecting unit 121 and the lateral position of the vehicle V and the amount of lateral change of the preceding vehicle LV detected by the lateral position detecting unit 122, thereby controlling steering of the vehicle V.

When there is no preceding vehicle LV that is traveling ahead of the vehicle V and the lateral position detecting unit 122 detects the lateral position of the vehicle V in the traffic lane, the steering control unit 124 performs a steering control so that the vehicle V is to travel along a center of the traffic lane, based on the lateral position and the steering angle detected by the steering angle detecting unit 121.

Also, when the preceding vehicle LV is traveling ahead of the vehicle V and the lateral position detecting unit 122 does not detect the lateral position of the vehicle V in the traffic lane, the steering control unit 124 performs a follow-up control so that the vehicle V is to follow up the lateral position of the preceding vehicle LV in the traffic lane, based on the amount of change of the preceding vehicle LV in the lateral direction with respect to the traffic lane, which is detected by the preceding vehicle detecting unit 123. In descriptions below, the amount of change of the preceding vehicle LV in the lateral direction with respect to the traffic lane is also referred to as ‘amount of lateral change’.

Specifically, in the case where the preceding vehicle LV is traveling ahead of the vehicle V, when the amount of lateral change detected by the preceding vehicle detecting unit 123 is less than a predetermined amount, the steering control unit 124 performs the follow-up control, and when the amount of lateral change is equal to or greater than the predetermined amount, the steering control unit 124 stops the follow-up control.

Here, in the case where the follow-up control is stopped, when the lateral position detecting unit 122 detects the lateral position of the vehicle V in the traffic lane, the steering control unit 124 may perform the steering control so that the vehicle V is to travel along a center of the traffic lane, based on the detected lateral position. Thereby, even if the vehicle V does not follow up the preceding vehicle LV, the vehicle control device 10 can cause the vehicle to stably travel in the traffic lane.

Also, in the case where the follow-up control is stopped, when the lateral position detecting unit 122 does not detect the lateral position of the vehicle V in the traffic lane, the steering control unit 124 may cause the motor 5 to stop the auxiliary assistance, thereby stopping the steering control. Also, in this case, the steering control unit 124 may control a notification means (not shown) such as a speaker, a lamp and the like provided to the vehicle V, thereby notifying a driver that the steering assistance by the motor 5 has stopped. Thereby, when the vehicle V does not follow up the preceding vehicle LV and cannot travel in the traffic lane by using the demarcation lines, the vehicle control device 10 can switch the steering of the vehicle V to the steering under control of the driver.

The speed control unit 125 is configured to obtain the speed information output from the speed sensor 4, and to obtain the preceding vehicle information output from the preceding vehicle detecting unit 123 or the non-detection information indicating that the preceding vehicle LV is not detected. When the speed control unit 125 obtains the non-detection information and determines that there is no preceding vehicle LV that is traveling ahead of the vehicle V, the speed control unit 125 controls the actuator 6 so that the vehicle V is to travel at a predetermined speed preset by the driver.

Also, when the speed control unit 125 obtains the preceding vehicle information and determines that the preceding vehicle LV is traveling ahead of the vehicle V, the speed control unit 125 controls the actuator 6 so that the vehicle V is to follow up the preceding vehicle LV. Specifically, the speed control unit 125 is configured to calculate a speed of the preceding vehicle LV, based on the speed of the vehicle V indicated by the speed information and the relative speed of the preceding vehicle LV indicated by the preceding vehicle information. When the speed of the preceding vehicle LV is equal to or lower than a predetermined speed preset by the driver, the speed control unit 125 controls the actuator 6 so that the vehicle V is to follow up the preceding vehicle LV.

[Flow of Processing of Steering Control that is Executed in Vehicle Control Device 10]

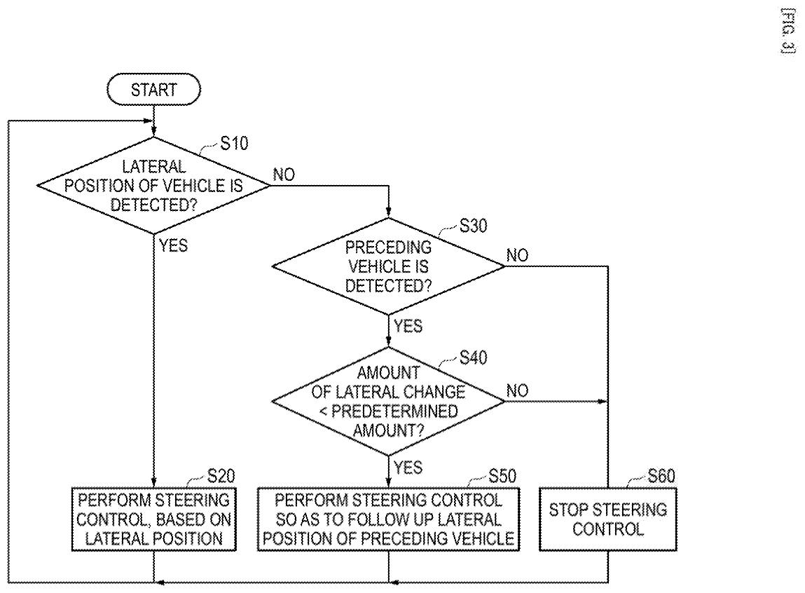

Subsequently, a flow of processing of the steering control that is executed in the vehicle control device 10 is described. FIG. 3 is a flowchart showing a flow of processing of the steering control that is executed in the vehicle control device 10 in accordance with the present embodiment.

First, the steering control unit 124 determines whether a lateral position of the vehicle V is detected by the lateral position detecting unit 122 (S10). When it is determined that the lateral position is detected, the steering control unit 124 proceeds to S20, and when it is determined that the lateral position is not detected, the steering control unit 124 proceeds to S30.

In S20, the steering control unit 124 performs the steering control so that the vehicle V is to travel along a center of the traffic lane, based on the lateral position detected by the lateral position detecting unit 122.

In S30, the steering control unit 124 determines whether the preceding vehicle LV is detected by the preceding vehicle detecting unit 123. When it is determined that the preceding vehicle LV is detected, the steering control unit 124 proceeds to S40, and when it is determined that the preceding vehicle LV is not detected, the steering control unit 124 proceeds to S60.

In S40, the steering control unit 124 determines whether the amount of lateral change of the preceding vehicle LV detected by the preceding vehicle detecting unit 123 is less than a predetermined amount. When it is determined that the amount of lateral change is less than the predetermined amount, the steering control unit 124 proceeds to S50. In S50, the steering control unit 124 performs the steering control so as to follow up the lateral position of the preceding vehicle LV.

When it is determined in S40 that the amount of lateral change is equal to or greater than the predetermined amount, the steering control unit 124 proceeds to S60.

The case where the processing of S60 is executed is a state where the lateral position of the vehicle V is not detected and the preceding vehicle LV is not detected, or a state where the lateral position of the vehicle V is not detected and the amount of lateral change of the preceding vehicle LV is equal to or greater than the predetermined amount. For this reason, in S60, the steering control unit 124 causes the motor 5 to stop the auxiliary assistance, thereby stopping the steering control.

### Effects of Present Embodiment

As described above, the vehicle control device 10 in accordance with the present embodiment includes the preceding vehicle detecting unit 123 configured to detect the amount of change of the preceding vehicle LV in the lateral direction with respect to the traffic lane, which is traveling ahead of the vehicle V in the traffic lane in which the vehicle V travels, and performs the follow-up control of controlling steering of the vehicle V so that the vehicle V is to follow up the lateral position of the preceding vehicle LV in the traffic lane, when the detected amount of change is less than the predetermined amount, and stops the follow-up control when the detected amount of change is equal to or greater than the predetermined amount. In this way, when the preceding vehicle LV is shakily traveling, the vehicle control device 10 stops the follow-up control to suppress the straight advancing from being deteriorated. Thereby, the vehicle control device 10 can cause the vehicle V to stably travel.

Although the present disclosure has been described with reference to the embodiment, the technical scope of the present disclosure is not limited to that described in the embodiment, and various modifications and changes can be made within the scope of the description. Also, for example, the specific embodiments of separated or integrated devices are not limited to the above embodiment, and all or a part thereof can be configured to be functionally or physically separated or integrated in any desired units.

The subject application is based on Japanese Patent Application No. 2017-213553 filed on Nov. 6, 2017, the contents of which are incorporated herein by reference.

### INDUSTRIAL APPLICABILITY

The present disclosure achieves the effect of causing the vehicle to stably travel, and is useful for the steering control device, the steering control method and the like.

### REFERENCE SIGNS LIST

1 . . . Steering angle sensor
2 . . . Imaging device
3 . . . Preceding vehicle detecting sensor
4 . . . Speed sensor
5 . . . Motor
6 . . . Actuator
10 . . . Vehicle control device
11 . . . Storage unit
12 . . . Control unit
121 . . . Steering angle detecting unit
122 . . . Lateral position detecting unit
123 . . . Preceding vehicle detecting unit
124 . . . Steering control unit
125 . . . Speed control unit
V . . . Vehicle

1. A steering control device comprising:
a controller configured to:
detect an amount of change of a preceding vehicle traveling ahead of a vehicle in a lateral direction with respect to a traffic lane in which the vehicle travels;
in a case the detected amount of change is less than a predetermined amount, perform a follow-up control of controlling steering of the vehicle such that the vehicle is to follow up a lateral position of the preceding vehicle in the traffic lane; and
in a case the detected amount of change is equal to or greater than the predetermined amount, stop the follow-up control.

2. The steering control device according to claim 1,
wherein the controller is further configured to:
obtain a captured image obtained by capturing a situation ahead of the vehicle in an advancing direction; and
in a case an image expressing demarcation lines of the traffic lane is included in the captured image, detect a lateral position of the vehicle in the traffic lane, based on the image expressing the demarcation lines,
wherein in a case the follow-up control is stopped, when the lateral position of the vehicle is detected in the detecting of the lateral position, the controller is configured to control steering of the vehicle based on the lateral position.

3. The steering control device according to claim 2,
wherein in the case the follow-up control is stopped, when the lateral position of the vehicle is not detected in the detecting of the lateral position, the controller is configured to stop the steering control of the vehicle.

4. A steering control method comprising:
detecting an amount of change of a preceding vehicle traveling ahead of a vehicle in a lateral direction with respect to a traffic lane in which the vehicle travels;
in a case the detected amount of change is less than a predetermined amount, performing a follow-up control of controlling steering of the vehicle such that the vehicle is to follow up a lateral position of the preceding vehicle in the traffic lane; and
in a case the detected amount of change is equal to or greater than the predetermined amount, stopping the follow-up control.

5. A non-transitory computer-readable storage medium storing a computer program readable by a computer of a vehicle, the computer program, when executed by the computer, causes the vehicle to perform:
detecting an amount of change of a preceding vehicle traveling ahead of a vehicle in a lateral direction with respect to a traffic lane in which the vehicle travels;
in a case the detected amount of change is less than a predetermined amount, performing a follow-up control of controlling steering of the vehicle such that the vehicle is to follow up a lateral position of the preceding vehicle in the traffic lane, and
in a case the detected amount of change is equal to or greater than the predetermined amount, stopping the follow-up control.
